(19) United States
(12) Patent Application Publication
(10) Pub. No.: US 2013/0249444 A1
(43) Pub. Date: Sep. 26, 2013

(54) HIGH INTEGRITY ROTARY ACTUATOR AND METHOD OF OPERATION

(71) Applicant: Terence Ross Golding, Tewkesbury (GB)

(72) Inventor: Terence Ross Golding, Tewkesbury (GB)

(21) Appl. No.: 13/424,884

(22) Filed: Mar. 20, 2012

(51) Int. Cl. H02P 5/695; H02K 7/116

(52) U.S. Cl. 318/8; 310/83

(57) ABSTRACT

An actuator for an aircraft is provided. The actuator comprises a first motor, a second motor and an actuator output, which are interconnected by a gear assembly. The actuator output is driveable by the first motor independently of the second motor; the actuator output is driveable by the second motor independently of the first motor; and the actuator output is driveable by the first and second motors in combination.

### BACKGROUND OF THE INVENTION

1. Field of the Invention

Embodiments of the present invention relates to rotary actuators and methods of their operation, in particular, the invention relates to rotary actuators and methods of their operation that are suitable for use in aircraft.

2. Description of Related Art

Actuation of safety critical mechanisms in safety critical systems or equipment needs to achieve a high level of reliability. It is generally known to use hydraulic actuators in aircraft, for example to operate landing gears and/or flaps and ailerons and so on, due to their reliability. Hydraulic system failure is usually caused by leakage of hydraulic fluid, and the system fails to a freely moveable state without jamming. In the case of hydraulically actuated landing gears, this fact allows the gears to be lowered for landing in spite of a system failure.

The utilization of electromechanical actuators is advantageous, because they are light in weight and can be incorporated into an aircraft simply and powered using the electric power distribution system within the aircraft. However, electric motors have a significant seizure failure mode, whereby they tend to fail to a jammed state, preventing backup systems becoming effective.

Known electric rotary actuators require a disconnect device, e.g. a clutch, to ensure that in the event of a failure that causes a system jam, the actuator can be freed to allow operation of a backup system. For example, one known jam tolerant electromechanical actuation system comprises at least two electric drive means and a coupling/decoupling mechanism provided at the output member of the actuator assembly for severing the load path between the actuator and the output. The coupling/decoupling mechanism uses a disconnect actuator to perform a coupling/decoupling operation.

In view of the foregoing, there exists a need to increase the reliability of rotary actuators as well as reduce their size, weight and complexity.

### BRIEF DESCRIPTION OF THE INVENTION

According to an embodiment of the present invention, an actuator for an aircraft is provided. The actuator comprises a first motor, a second motor and an actuator output , which are interconnected by a gear assembly . The actuator output is driveable by the first motor independently of the second motor; the actuator output is driveable by the second motor independently of the first motor; and the actuator output is driveable by the first and second motors in combination.

According to another embodiment of the present invention, a method of operating an actuator comprising a first motor, a second motor and an actuator output, which are interconnected by a gear assembly, is provided. The method comprises operating the first drive means to drive the actuator output, operating the second motor to drive the actuator output in the event of a fault with the first motor, and operating the first and second motors in combination to drive the actuator output in the event of a fault with the gear assembly that interconnects the first and second motors.

### BRIEF DESCRIPTION OF THE DRAWINGS

There follows a detailed description of embodiments of the present invention by way of example only and made with reference to the accompanying schematic drawings, in which:

FIG. 1 is a cross-sectional view of an actuator according to an embodiment of the present invention;

FIG. 2 is a cross-sectional view through the gear assembly according to an embodiment of the present invention;

FIG. 3 is a cross-sectional view of an embodiment of the present invention; and

FIG. 4 is a cross-sectional view of an embodiment of the present invention.

### DETAILED DESCRIPTION OF THE INVENTION

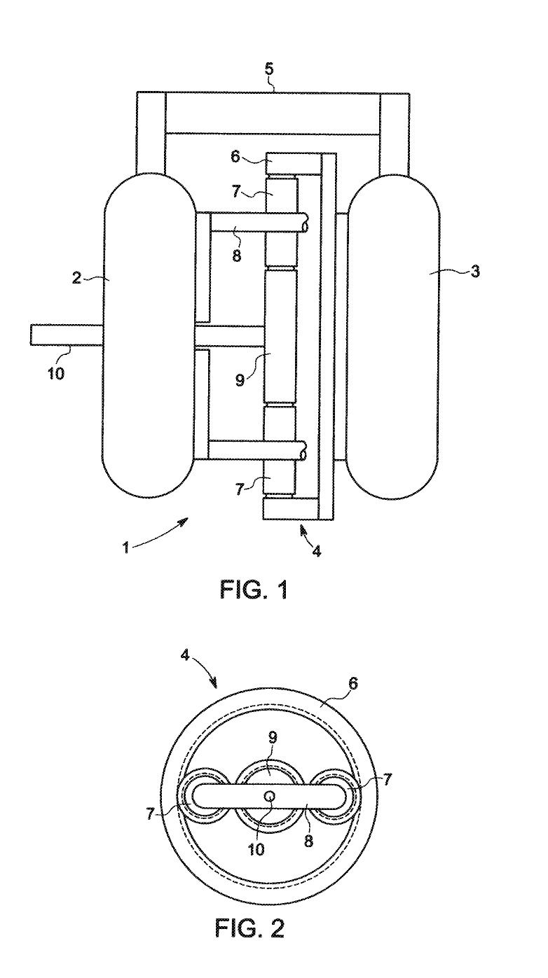

FIG. 1 shows a cross-section through an actuator comprising a first motor 2 and second motor 3. The first and second motors2,3 are interconnected by a gear assembly 4 which comprises a planetary gear system (also known as an epicyclic gear system). Each of the two motors 2,3 comprises an electric motor whose output is connected to a harmonic drive, to reduce the speed and increase the torque of the motor output. The actuator is located within a casing (not shown), to which it is held fast by a harmonic drive grounding 5.

The planetary gear assembly 4 comprises an internally toothed outer ring gear 6 within which are mounted two or more externally toothed planet gears 7, the teeth of which engage with the teeth of the outer ring gear. The assembly 4 further includes a planet gear carrier 8 which has a number of shafts on which the planet gears 7 are journalled. An externally toothed central sun gear 9 is disposed in driving connection with the planet gears 7. Other types of gear assembly can be used in the embodiments of the present invention without departing from the scope of the claims.

In the embodiment of FIG. 1, the first motor 2 is connected to the planetary carrier 8 of the gear assembly 4 and the second motor 3 is connected to the outer ring gear 6. The actuator has an output 10 which is connected to the sun gear 9. The output 10 can pass through the first motor 2 where necessary.

The operation of the embodiment shown in FIG. 1 is illustrated in the following table covering the different failure scenarios that can affect the actuator. The arrows in the table show the direction of rotation of each input or motor 2,3 and the resulting direction of rotation of the output 10. As can be seen from the table, for the actuator to cease operating, failure of both motors is required. In any of the other failure scenarios listed, the actuator continues to function.

| INPUT 1 | INPUT 2 | OPERATION/FAULT | OUTPUT |
|---|---|---|---|
| 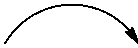 | | Input 2 off or seized | 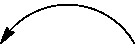 |
| | 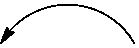 | Input 1 off or seized | 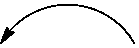 |
| 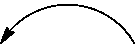 | | Input 2 off or seized | 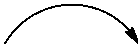 |
| | 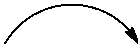 | Input 1 off or seized | 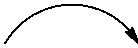 |
| 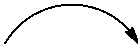 | 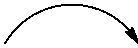 | Epi-cyclic gear jam | 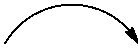 |
| 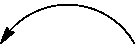 | 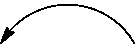 | Epi-cyclic gear jam | 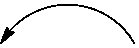 |

FIG. 2 shows a cross-section through the gear assembly 4 illustrating the configuration of the sun gear 9, the planetary gears 7 and the outer ring gear 6.

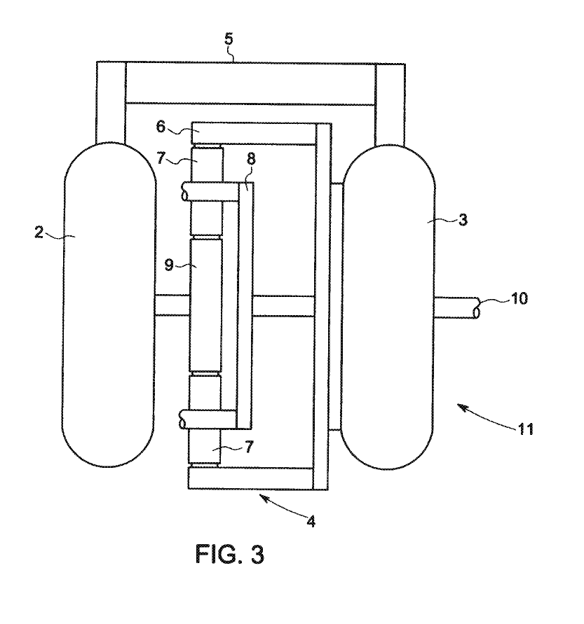

FIG. 3 shows a cross-section through an alternative embodiment of the invention, wherein the first motor 2 is connected to the sun gear 9 and the second motor is connected to the outer ring gear 6. The output 10 is connected to the planetary carrier 8 and passes through the second motor.

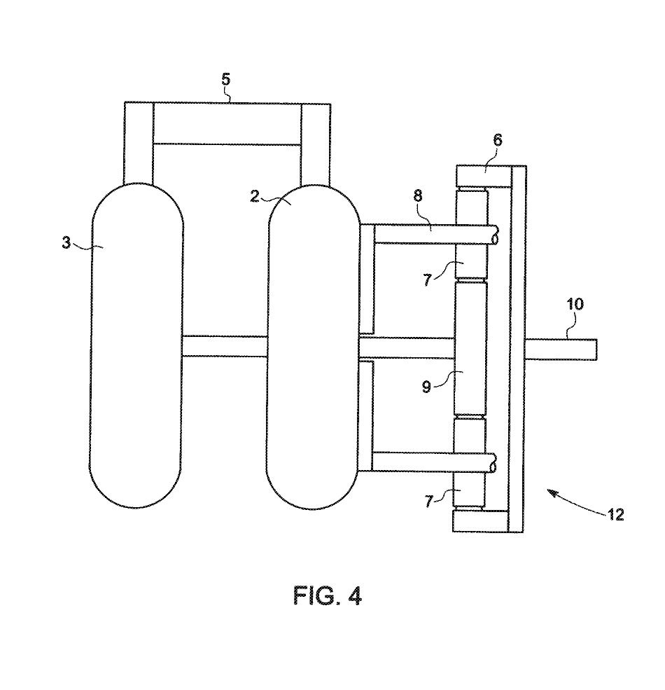

In the further embodiment shown in FIG. 4, the first motor 2 is connected to the planetary carrier 8 and the second motor 3 is connected to the sun gear 9 via a shaft which passes through the first motor. The output 10 is connected to the outer ring gear 6.

Each of the embodiments can provide different ratios of input speed to output speed and the ratio depends on the mode of operation of the actuator. Embodiments are envisaged which utilize more than two motors and these would require additional epicyclic gears driven by the output of the actuator.

In a further embodiment, not shown in the drawings, one of the first and second motors comprises an electric motor and the other comprises a hydraulic motor. This embodiment provides additional protection against a common cause failure, such as failure of the electrical system or failure of the hydraulic system.

In all of the embodiments, the motors are not back-drivable in order to ensure the epicyclic gears operate as shown in the table. The harmonic drives help to ensure non back-driveability by providing a large gear reduction ratio to the motor output.

In normal operation of the actuator, the first and second motors are operated alternately. Thus, for example, for one flight the first motor only is used to operate the actuator and during the next flight, only the second motor is used to operate the actuator, assuming of course that none of the failure situations occur. In this way, it is demonstrated on a regular basis that both of the motors were functional for the last duty cycle.

The gear ratios of the components of the gear assembly 4 can be chosen to optimize the actuator for a particular application. Some of the limiting factors in this regard are the space available for the diameter of the outer ring gear, gear tooth dimensions for stress and fatigue reasons, the output load and speed required and the motor torque and speed obtainable.

By combining multiple motors in an actuator, the actuator is continuously operable in the event of a failure of either of the motors or jamming of the gear assembly. Further, the gear assembly avoids the use of clutches, whereby the actuator has a low weight and size and increased reliability.

What is claimed is:

1. An actuator for an aircraft, the actuator comprising:
a first motor, a second motor and an actuator output, which are interconnected by a gear assembly, wherein the actuator output is driveable by the first motor independently of the second motor, wherein the actuator output is driveable by the second motor independently of the first motor; and wherein the actuator output is driveable by the first and second motors in combination.

2. The actuator according to claim 1, wherein the first and second motors comprise respective electric motors.

3. The actuator according to claim 1, wherein the first and second motors comprise respective hydraulic motors.

4. The actuator according to claim 1, wherein at least one of the first and second motors comprises an electric motor and at least one of the first and second motors comprises a hydraulic motor.

5. The actuator according to claim 1, wherein the first motor is connected to the gear assembly via a harmonic drive.

6. The actuator according to claim 1, wherein the second motor is connected to the gear assembly via a harmonic drive.

7. The actuator according to claim 1, wherein the gear assembly comprises an epicyclic gear assembly comprising an outer ring gear drivingly connected to a set of planetary gears and a planet carrier, which are drivingly connected to a sun gear.

8. The actuator according to claim 7, wherein the first motor is disposed in driving connection with the planet carrier.

9. The actuator according to claim 7, wherein the second motor is disposed in driving connection with the outer ring gear.

10. The actuator according to claim 7, wherein the actuator output is disposed in driving connection with the sun gear.

11. The actuator according to claim 7, wherein the first motor is disposed in driving connection with the sun gear, the second motor is disposed in driving connection with the outer ring gear and the actuator output is disposed in driving connection with the planet carrier.

12. The actuator according to claim 7, wherein the first motor is disposed in driving connection with the planet carrier, the second motor is disposed in driving connection with the sun gear and the actuator output is disposed in driving connection with the outer ring gear.

13. A landing gear system comprising an actuator according to claim 1.

14. An aircraft flap or aileron control system comprising an actuator according to claim 1.

15. A method of operating an actuator comprising a first motor, a second motor and an actuator output, which are interconnected by a gear assembly, the method comprising:
operating the first motor to drive the actuator output;
operating the second motor to drive the actuator output in the event of a fault with the first motor; and
operating the first and second motors in combination to drive the actuator output in the event of a fault with the gear assembly that interconnects the first and second motors.

16. The method according to claim 15, wherein during normal operation of the actuator, the first and second motors are operated alternately.
